(19) United States
(12) Patent Application Publication
(10) Pub. No.: US 2026/0361495 A1
(43) Pub. Date: Nov. 12, 2026

(54) PORT MULTIPLEXING METHOD AND APPARATUS, TERMINAL, NETWORK-SIDE DEVICE, AND MEDIUM

(71) Applicant: VIVO MOBILE COMMUNICATION CO., LTD., Dongguan (CN)

(72) Inventor: Kaili ZHENG, Dongguan (CN)

(73) Assignee: VIVO MOBILE COMMUNICATION CO., LTD., Dongguan (CN)

(21) Appl. No.: 19/723,171

(22) Filed: Jun. 29, 2026

Related U.S. Application Data
(63) Continuation of application No. PCT/CN2024/142896, filed on Dec. 26, 2024.

(30) Foreign Application Priority Data
Dec. 29, 2023 (CN) 202311874120.X

(51) Int. Cl. H04L 5/00; H04W 72/0453

(52) U.S. Cl. CPC H04L 5/0051; H04W 72/0453

(57) ABSTRACT

A port multiplexing method and apparatus, a terminal, a network-side device, and a medium, are provided. The port multiplexing method includes: receiving, by a terminal, a first reference signal; where the first reference signal includes one or more types of basic resource sets, each type of the basic resource sets includes one or more resource elements, and a port of the first reference signal is multiplexed onto one or more of the basic resource sets.

### CROSS-REFERENCE TO RELATED APPLICATIONS

This application is a continuation of International Application No. PCT/CN2024/142896, filed Dec. 26, 2024, which claims priority to Chinese Patent Application No. 202311874120.X, filed Dec. 29, 2023. The entire contents of each of the above-referenced applications are expressly incorporated herein by reference.

### TECHNICAL FIELD

This application pertains to the field of communication technologies, and specifically relates to a port multiplexing method and apparatus, a terminal, a network-side device, and a medium.

### BACKGROUND

In a New Radio (NR) system, the maximum number of ports of a Channel State Information Reference Signal (CSI-RS) resource can reach 32. However, terminals with different capabilities may not support the same maximum number of CSI-RS ports. As a result, a network-side device needs to configure different CSI-RS resources for the terminals with different capabilities, which leads to large overall CSI-RS resource overheads in the network.

### SUMMARY

Embodiments of this application provide a port multiplexing method and apparatus, a terminal, a network-side device, and a medium.

According to a first aspect, a port multiplexing method performed by a terminal is provided. The method includes: receiving, by the terminal, a first reference signal; where the first reference signal includes one or more types of basic resource sets, each type of the basic resource sets includes one or more resource elements, and a port of the first reference signal is multiplexed onto one or more of the basic resource sets.

According to a second aspect, a port multiplexing method performed by a network-side device is provided. The method includes: sending, by the network-side device, a first reference signal; where the first reference signal includes one or more types of basic resource sets, each type of the basic resource sets includes one or more resource elements, and a port of the first reference signal is multiplexed onto one or more of the basic resource sets.

According to a third aspect, a port multiplexing apparatus is provided. The apparatus includes a receiving module. The receiving module is configured to receive a first reference signal; where the first reference signal includes one or more types of basic resource sets, each type of the basic resource sets includes one or more resource elements, and a port of the first reference signal is multiplexed onto one or more of the basic resource sets.

According to a fourth aspect, a port multiplexing apparatus is provided. The apparatus includes a sending module. The sending module is configured to send a first reference signal; where the first reference signal includes one or more types of basic resource sets, each type of the basic resource sets includes one or more resource elements, and a port of the first reference signal is multiplexed onto one or more of the basic resource sets.

According to a fifth aspect, a terminal is provided. The terminal includes a processor and a memory, where the memory stores a program or instructions capable of running on the processor, and when the program or instructions are executed by the processor, the steps of the method according to the first aspect are implemented.

According to a sixth aspect, a terminal is provided, including a processor and a communication interface. The communication interface is configured to receive a first reference signal; where the first reference signal includes one or more types of basic resource sets, each type of the basic resource sets includes one or more resource elements, and a port of the first reference signal is multiplexed onto one or more of the basic resource sets.

According to a seventh aspect, a network-side device is provided. The network-side device includes a processor and a memory, where the memory stores a program or instructions capable of running on the processor, and when the program or instructions are executed by the processor, the steps of the method according to the second aspect are implemented.

According to an eighth aspect, a network-side device is provided, including a processor and a communication interface. The communication interface is configured to send a first reference signal; where the first reference signal includes one or more types of basic resource sets, each type of the basic resource sets includes one or more resource elements, and a port of the first reference signal is multiplexed onto one or more of the basic resource sets.

According to a ninth aspect, a readable storage medium is provided, where the readable storage medium stores a program or instructions, and when the program or instructions are executed by a processor, the steps of the method according to the first aspect are implemented, or the steps of the method according to the second aspect are implemented.

According to a tenth aspect, a wireless communication system is provided, including a terminal and a network-side device. The terminal may be configured to perform the steps of the method according to the first aspect, and the network-side device may be configured to perform the steps of the method according to the second aspect.

According to an eleventh aspect, a chip is provided. The chip includes a processor and a communication interface. The communication interface is coupled to the processor, and the processor is configured to run a program or instructions to implement the method according to the first aspect or the method according to the second aspect.

According to a twelfth aspect, a computer program/program product is provided, where the computer program/program product is stored in a storage medium, and the program/program product is executed by at least one processor to implement the steps of the method according to the first aspect or the steps of the method according to the second aspect.

In the embodiments of this application, the terminal receives the first reference signal; where the first reference signal includes one or more types of basic resource sets, each type of the basic resource sets includes one or more resource elements, and a port of the first reference signal is multiplexed onto one or more of the basic resource sets. In this solution, the terminal can receive the first reference signal including one or more types of basic resource sets, and the port of the first reference signal is multiplexed onto one or more of the basic resource sets.

### BRIEF DESCRIPTION OF DRAWINGS

FIG. 1 is a block diagram of a wireless communication system to which embodiments of this application are applicable;

FIG. 2 is a flowchart of a port multiplexing method according to an embodiment of this application;

FIG. 3 is a schematic diagram of a pattern of a basic resource set including one resource element in a port multiplexing method according to an embodiment of this application;

FIG. 4 is a schematic diagram of a pattern of a basic resource set including two resource elements in a port multiplexing method according to an embodiment of this application;

FIG. 5 is a schematic diagram of a pattern of a basic resource set including four resource elements in a port multiplexing method according to an embodiment of this application;

FIG. 6 is a first schematic diagram of time-frequency resource occupancy in one Resource Block (RB) in a port multiplexing method according to an embodiment of this application;

FIG. 7 is a second schematic diagram of time-frequency resource occupancy in one RB in a port multiplexing method according to an embodiment of this application;

FIG. 8 is a third schematic diagram of time-frequency resource occupancy in one RB in a port multiplexing method according to an embodiment of this application;

FIG. 9 is a fourth schematic diagram of time-frequency resource occupancy in one RB in a port multiplexing method according to an embodiment of this application;

FIG. 10 is a flowchart of another port multiplexing method according to an embodiment of this application;

FIG. 11 is a schematic structural diagram of a port multiplexing apparatus according to an embodiment of this application;

FIG. 12 is a schematic structural diagram of another port multiplexing apparatus according to an embodiment of this application;

FIG. 13 is a schematic diagram of a communication device according to an embodiment of this application;

FIG. 14 is a schematic diagram of a hardware structure of a terminal according to an embodiment of this application; and

FIG. 15 is a schematic diagram of a hardware structure of a network-side device according to an embodiment of this application.

### DETAILED DESCRIPTION

The following describes the technical solutions in the embodiments of this application with reference to the accompanying drawings in the embodiments of this application. Apparently, the described embodiments are only some rather than all of the embodiments of this application. All other embodiments obtained by persons of ordinary skill in the art based on the embodiments of this application fall within the protection scope of this application.

The terms “first,” “second,” and the like in this application are used to distinguish between similar objects rather than to describe a specific order or sequence. It should be understood that the terms used in this way are interchangeable in appropriate circumstances such that the embodiments of this application can be implemented in other orders than the order illustrated or described herein. In addition, objects distinguished by “first” and “second” are generally of a same type, and the quantities of the objects are not limited. For example, there may be one or more first objects. In addition, “or” in this application represents at least one of connected objects. For example, “A or B” represents the following three cases: including A but not including B, including B but not including A, and including both A and B. The character “/” generally indicates an “or” relationship between the contextually associated objects.

The term “indicate” in this application may be a direct indication (or explicit indication) or an indirect indication (or implicit indication). The direct indication can be understood as that the sender explicitly informs the receiver of specific information, operations to be performed, or requested results in the sent indication. The indirect indication can be understood as that the receiver determines corresponding information based on the indication sent by the sender, or makes a judgment and determines operations to be performed or requested results based on the judgment result.

It should be noted that technologies described in the embodiments of this application are not limited to Long Term Evolution (LTE) or LTE-Advanced (LTE-A) systems, and may also be applied to other wireless communication systems, for example, Code Division Multiple Access (CDMA), Time Division Multiple Access (TDMA), Frequency Division Multiple Access (FDMA), Orthogonal Frequency Division Multiple Access (OFDMA), Single-Carrier Frequency-Division Multiple Access (SC-FDMA), or other systems. The terms “system” and “network” in the embodiments of this application are often used interchangeably, and the technology described herein may be used in the above-mentioned systems and radio technologies as well as other systems and radio technologies. However, in the following descriptions, an NR system is described for illustration purposes, NR terms are used in most of the following descriptions, and these technologies may also be applied to other systems than the NR system, for example, the 6th Generation (6G) communication system.

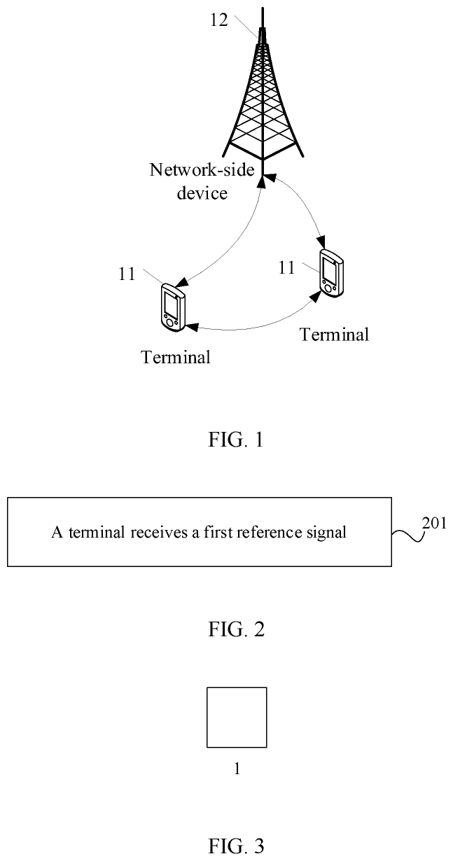

FIG. 1 is a block diagram of a wireless communication system to which the embodiments of this application are applicable. The wireless communication system includes a terminal 11 and a network-side device 12. The terminal 11 may be pedestrian user equipment (Pedestrian User Equipment, PUE). The PUE may be a terminal-side device, such as a mobile phone, a tablet personal computer, a laptop computer, a notebook computer, a personal digital assistant (PDA), a palmtop computer, a netbook, an ultra-mobile personal computer (UMPC), a mobile internet device (MID), an augmented reality (AR) device, a virtual reality (VR) device, a wearable device, or a smart appliance. The wearable device includes a smart watch, a smart band, a smart earphone, smart glasses, smart jewelry (a smart bangle, a smart bracelet, a smart ring, a smart necklace, a smart ankle bangle, a smart anklet, or the like), a smart wristband, smart clothing, or the like. The vehicle user equipment may also be referred to as a vehicle terminal, a vehicle controller, a vehicle module, a vehicle component, a vehicle chip, a vehicle unit, or the like. It should be noted that the terminal 11 is not limited to any specific type in the embodiments of this application. The network-side device 12 may include an access network device or a core network device, where the access network device may also be referred to as a Radio Access Network (RAN) device, a radio access network function, or a radio access network unit. The access network device may include a base station, a Wireless Local Area Network (WLAN) Access Point (AS), a Wireless Fidelity (WiFi) node, or the like. The base station may be referred to as a NodeB (NB), an Evolved NodeB (eNB), the next generation NodeB (the next generation Node B (gNB)), a New Radio NodeB (NR Node B), an access point, a Relay Base Station (RBS), a Serving Base Station (SBS), a Base Transceiver Station (BTS), a radio base station, a radio transceiver, a Basic Service Set (BSS), an Extended Service Set (ESS), a home NodeB (HNB), a home evolved NodeB (home evolved Node B), a Transmission Reception Point (TRP), or other appropriate terms in the art. Provided that the same technical effects are achieved, the base station is not limited to any specific technical term. It should be noted that in the embodiments of this application, only the base station in the NR system is used as an example for description, although the specific type of the base station is not limited.

The following describes in detail the port multiplexing method and apparatus, terminal, network-side device, and medium provided in the embodiments of this application through some embodiments and application scenarios thereof with reference to the accompanying drawings.

In the NR system, the CSI-RS has extensive functions, and can be used for channel state information (Channel State Information, CSI) measurement, beam measurement, interference measurement, rate matching, time/frequency tracking, and the like. Specifically, the CSI-RS can be roughly divided into the following two types:
1. Non-zero power CSI-RS (Non Zero Power CSI-RS, NZP-CSI-RS), used for at least one of the following:
CSI measurement: measuring Pre-coding Matrix Indication (PMI), Rank Indication (RI), Channel Quality Indication (CQI), and Layer Indicator (LI);
beam measurement: measuring Layer-1 Reference Signal Received Power, L1-RSRP) and Layer-1 Signal to Interference plus Noise Ratio, L1-SINR) (up to two ports); and
interference measurement: measuring intra-cell interference, for example, for Multi-User Multiple-Input Multiple-Output (MU-MIMO) scheduling.
2. Zero power CSI-RS (Zero Power CSI-RS, ZP-CSI-RS), satisfying at least one of the following:
informs the terminal that a certain block of resources is occupied by CSI-RS/CSI interference measurement (CSI Interference Measurement, CSI-IM) of other terminals;
prevents the terminal from considering that resource elements (Resource Element, RE) occupied by the ZP-CSI-RS have no transmission power;
causes the terminal to only consider that the REs occupied by the ZP-CSI-RS cannot be occupied by a physical downlink shared channel (Physical Downlink Shared Channel, PDSCH); and
has the same structure as the NZP-CSI-RS except for the absence of a substantive transmission sequence.

Currently, the radio resource control (Radio Resource Control, RRC) parameter CSI-RS-ResourceMapping can be used to configure information of the CSI-RS resource, such as the number of ports, multiplexing scheme, time-frequency resources, and density. In the current NR system, the CSI-RS supports up to 32 ports. Different ports can be multiplexed using time division multiplexing (Time Division Multiplexing, TDM), frequency division multiplexing (Frequency Division Multiplexing, FDM), or code division multiplexing (Code Division Multiplexing, CDM). For CDM, according to different numbers of ports, the following three orthogonal cover code (Orthogonal Cover Code, OCC) multiplexing schemes are supported: FD-CDM2, CDM4 (FD2, TD2), and CDM8 (FD2, TD4).

In addition, CSI-RS port indices can be sorted in the order of code domain first, then frequency domain, and finally time domain. Starting from the smallest subcarrier index and the smallest symbol index, port indices in the first CDM group are determined, and port indices within the same CDM group are determined based on the OCC sequence used. Then, CSI-RS port indices in CDM groups on larger subcarriers at the same symbol index are determined. If there are no more CDM groups on the same symbol, CDM groups are determined at larger symbol indices, and then CSI-RS port indices are determined.

The CSI-RS in the current NR system supports up to 32 ports, but resources with different numbers of ports cannot be fully compatible, that is, in some cases, it is difficult to extract some orthogonal ports from CSI-RS resources with a larger number of ports. For example, it is impossible to separate orthogonal 1-port, 2-port, and 4-port CSI-RSs from a 32-port CSI-RS resource based on CDM8 (FD2, TD4) or separate orthogonal 1-port and 2-port CSI-RSs from a 32-port CSI-RS resource based on CDM4 (FD2, TD2). As a result, different CSI-RS resources need to occupy different time-frequency resources. Although the base station can configure the same CSI-RS resource for all terminals in the network-side configuration, due to the difference in terminal capabilities, terminals with different capabilities may not support the same CSI-RS ports. In this case, the base station needs to configure different CSI-RS resources for the terminals with different capabilities, which leads to large overall CSI-RS resource overheads in the network. Especially in future larger massive MIMO (that is, massive multiple-input multiple-output) scenarios, when CSI-RS resources with more ports (for example, 256 or 512 ports) are introduced, the number of antennas at the base station may increase several times, further aggravating the overall CSI-RS resource overheads in the network.

To solve the foregoing problems, the embodiments of this application provide a port multiplexing method and apparatus, a terminal, a network-side device, and a medium. In the port multiplexing method provided in the embodiments of this application, a terminal can receive a first CSI-RS; where the first CSI-RS includes one or more types of basic resource sets, each type of the basic resource sets includes one or more resource elements, and a port of the first CSI-RS is multiplexed onto one or more of the basic resource sets. In this solution, the terminal can receive the first CSI-RS including one or more types of basic resource sets, and the port of the first CSI-RS is multiplexed onto one or more of the basic resource sets, so that a plurality of CSI-RSs with different numbers of ports can be multiplexed onto the same time-frequency resource, thereby reducing the overall reference signal resource overheads in the network and improving the efficiency of data transmission.

An embodiment of this application provides a port multiplexing method. FIG. 2 is a flowchart of the port multiplexing method according to the embodiment of this application. As shown in FIG. 2, the port multiplexing method according to the embodiment of this application may include step 201 below.

Step 201: A terminal receives a first reference signal.

The first reference signal includes one or more types of basic resource sets, each type of the basic resource sets includes one or more resource elements (that is, REs), and a port of the first reference signal is multiplexed onto one or more of the basic resource sets.

In the embodiments of this application, the first reference signal can be used for channel state information measurement; for example, the first reference signal may be a CSI-RS.

In the embodiments of this application, any two of the plurality of types of basic resource sets include different numbers of resource elements.

In the embodiments of this application, when one basic resource set includes one resource element, one port of the first reference signal may be mapped on the basic resource set.

In the embodiments of this application, when one basic resource set includes a plurality of resource elements, one or more ports of the first reference signal may be mapped on the basic resource set.

It should be noted that in the embodiments of this application, one resource element corresponding to one subcarrier and one symbol is used as an example for illustration. In actual implementation, one resource element can correspond to any one of the following: one subcarrier and one symbol, a plurality of subcarriers and one symbol, one subcarrier and a plurality of symbols, and a plurality of subcarriers and a plurality of symbols, which can be specifically determined based on actual needs and is not limited in the embodiments of this application.

In the embodiments of this application, each of the one or more types of the basic resource sets includes a plurality of resource elements.

The plurality of resource elements may include at least one of the following 1.1 to 1.4:
1.1. a plurality of resource elements that are consecutive or non-consecutive in frequency domain at a same time-domain position;
1.2. a plurality of resource elements that are consecutive or non-consecutive in time domain at a same frequency-domain position;
1.3. a plurality of resource elements occupying at least one time-domain position; and
1.4. a plurality of frequency-domain elements occupying at least one frequency-domain position.

In the embodiments of this application, when the plurality of resource elements include a plurality of resource elements that are non-consecutive at the same time-domain position, the plurality of resource elements may be a plurality of resource elements with a spacing of X resource elements (that is, a plurality of resource elements with equal frequency domain spacing), where X is a positive integer, or the plurality of resource elements may be a plurality of resource elements with some consecutive resource elements, where the consecutive resource elements can be one resource element group and there is a spacing between different resource element groups.

In the embodiments of this application, when the plurality of resource elements include a plurality of resource elements that are non-consecutive at the same frequency-domain position, the plurality of resource elements may be a plurality of resource elements with a spacing of Y symbols (that is, a plurality of resource elements with equal time domain spacing), where Y is a positive integer, or the plurality of resource elements may be a plurality of resource elements with some consecutive resource elements, where the consecutive resource elements can be one resource element group and there is a spacing between different resource element groups.

In the embodiments of this application, since the plurality of resource elements included in each type of the basic resource sets may be at least one of 1.1 to 1.4, the composition patterns of each type of the basic resource sets can be enriched, thereby improving the flexibility in multiplexing the port of the first reference signal onto the one or more of the basic resource sets.

In the embodiments of this application, the port of the first reference signal may be multiplexed in at least one of the following manners 2.1 to 2.4:
2.1. multiplexing on one of the basic resource sets using an FD-OCC sequence;
2.2. multiplexing on one of the basic resource sets using a TD-OCC sequence;
2.3. multiplexing among the plurality of basic resource sets using TDM; and
2.4. multiplexing among the plurality of basic resource sets using FDM.

In the embodiments of this application, when the plurality of resource elements include 1.1 (that is, a plurality of resource elements that are consecutive or non-consecutive in frequency domain at a same time-domain position), the port of the first reference signal may be multiplexed in the manner in 2.1 (that is, multiplexing on one of the basic resource sets using an FD-OCC sequence). If the first reference signal has one port, the FD-OCC sequence can be understood as an all-1 sequence.

In the embodiments of this application, when the plurality of resource elements include 1.2 (that is, a plurality of resource elements that are consecutive or non-consecutive in time domain at a same frequency-domain position), the port of the first reference signal may be multiplexed in the manner in 2.2 (that is, multiplexing on one of the basic resource sets using a TD-OCC sequence). If the first reference signal has one port, the TD-OCC sequence can be understood as an all-1 sequence.

In the embodiments of this application, when the plurality of resource elements include at least one of the following A to D, 1.3 (that is, a plurality of resource elements occupying at least one time-domain position), and 1.4 (that is, a plurality of frequency-domain elements occupying at least one frequency-domain position), the port of the first reference signal may be multiplexed in at least one of the manner in 2.1 (that is, multiplexing on one of the basic resource sets using an FD-OCC sequence) and the manner in 2.2 (that is, multiplexing on one of the basic resource sets using a TD-OCC sequence):
A. a plurality of resource elements that are consecutive in frequency domain at a same time-domain position, and a plurality of resource elements that are consecutive in time domain at a same frequency-domain position;
B. a plurality of resource elements that are consecutive in frequency domain at a same time-domain position, and a plurality of resource elements that are non-consecutive in time domain at a same frequency-domain position;
C. a plurality of resource elements that are non-consecutive in frequency domain at a same time-domain position, and a plurality of resource elements that are consecutive in time domain at a same frequency-domain position; and
D. a plurality of resource elements that are non-consecutive in frequency domain at a same time-domain position, and a plurality of resource elements that are non-consecutive in time domain at a same frequency-domain position.

In the embodiments of this application, when the plurality of resource elements include at least one of 1.3 (that is, a plurality of resource elements occupying at least one time-domain position) and 1.4 (that is, a plurality of frequency-domain elements occupying at least one frequency-domain position), the port of the first reference signal may alternatively not be multiplexed based on an OCC sequence. In this case, one port of the first reference signal is mapped to a plurality of resource elements in one basic resource set.

In the embodiments of this application, the FD-OCC sequence or the TD-OCC sequence may include at least one of the following: Walsh sequence (that is, Walsh sequence), discrete Fourier transform (Discrete Fourier Transform, DFT) sequence, Grassmann sequence, and computer generate sequence (Computer Generate Sequence, CGS).

In the embodiments of this application, when the plurality of resource elements include at least one of 1.1 to 1.4, the port of the first reference signal may alternatively be multiplexed using at least one of TDM and FDM.

In the embodiments of this application, since the port of the first reference signal may be multiplexed in at least one of the manners in 2.1 to 2.4, the port of the first reference signal may be multiplexed in different manners, thereby improving the flexibility of reference signal port multiplexing.

In the embodiments of this application, each type of the basic resource sets includes a plurality of resource elements, and a length of a first sequence may be related to a number of first resource elements.

The first sequence is the FD-OCC sequence, and the first resource elements are a plurality of resource elements in frequency domain; or the first sequence is the TD-OCC sequence, and the first resource elements are a plurality of resource elements in time domain.

In the embodiments of this application, the length of the first sequence being related to the number of first resource elements can be understood as: the length of the first sequence is equal to or a multiple of the number of a plurality of resource elements included in the first resource element.

For example, if the first resource element includes K resource elements, the length of the first sequence is K or an integer multiple of K, where K is a positive integer.

In the embodiments of this application, since the length of the first sequence may be related to the number of first resource elements, the port of the first reference signal may be multiplexed based on the first sequence whose length is related to the number of first resource elements, thereby improving the accuracy of reference signal port multiplexing.

The following describes the port multiplexing method provided in the embodiments of this application using examples with reference to the accompanying drawings.

For example, taking the first reference signal being the CSI-RS as an example, as shown in FIG. 3, one basic resource set includes one RE. In this case, only one CSI-RS port is mapped on one basic resource set, but this does not mean that one CSI-RS port can only be mapped to one basic resource set. For example, for one CSI-RS port, the CSI-RS port may be mapped to (or occupy) a plurality of RBs and mapped to (or occupy) a plurality of REs in one RB.

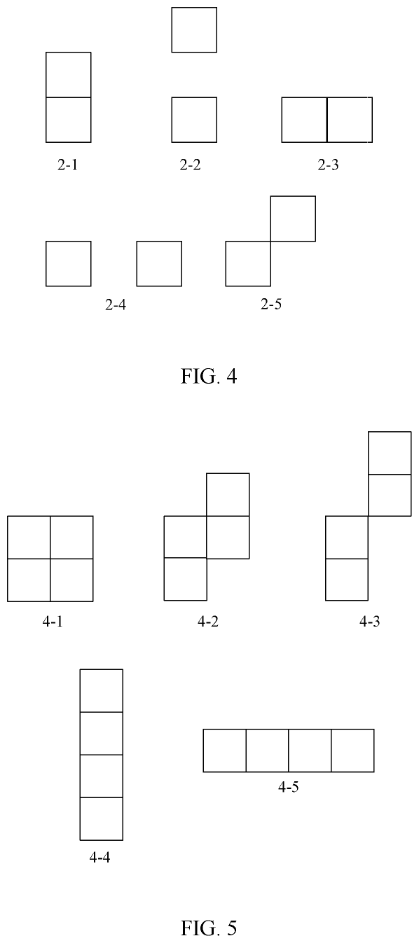

For another example, taking the first reference signal being the CSI-RS as an example, as shown in FIG. 4, one basic resource set includes two REs.

The basic resource set 2-1 occupies two consecutive REs on the same symbol, and this pattern (pattern) is suitable for scenarios with small frequency-domain delay and is beneficial for channel measurement in frequency domain. The basic resource set 2-2 occupies two non-consecutive REs on the same symbol, with a spacing of one RE between the two REs. Compared with the basic resource set 2-1, this pattern has the advantage of obtaining frequency-domain diversity gain through greater frequency-domain dispersion. The basic resource set 2-3 occupies two consecutive REs in time domain on the same subcarrier, and this pattern is suitable for scenarios with large delay extension but small mobility (Doppler). The basic resource set 2-4 occupies two non-consecutive REs in time domain on the same subcarrier, with a spacing of one RE between the two REs. Compared with the basic resource set 2-3, this pattern has the advantage of obtaining time-domain diversity gain through greater time-domain dispersion, and is also beneficial for estimation and processing of time-domain characteristics such as frequency offset. The basic resource set 2-5 occupies two subcarriers and two symbols, that is, occupies the first subcarrier on the first symbol and the second subcarrier on the second symbol. Compared with the basic resource sets 2-1 to 2-4, this pattern can obtain diversity gains in both frequency domain and time domain, and can also be used to reduce the CSI-RS resource occupancy overheads when the similar measurement effects are achieved.

When the basic resource sets 2-1 and 2-2 are used to map one CSI-RS port, CDM multiplexing of the port does not require an OCC sequence (or understood as an all-1 OCC sequence, the same below); and when used to map two CSI-RS ports, CDM multiplexing of the two CSI-RS ports can be performed using an OCC sequence of length 2 (that is, FD-OCC). When the basic resource sets 2-3 and 2-4 are used to map one CSI-RS port, CDM multiplexing of the port does not require an OCC sequence; and when used to map two CSI-RS ports, CDM multiplexing of the two CSI-RS ports can be performed using an OCC sequence of length 2 (that is, TD-OCC). When the basic resource set 2-5 is used to map one CSI-RS port, CDM multiplexing of the port does not require an OCC sequence; and when used to map two CSI-RS ports, multiplexing of the two CSI-RS ports can still be performed using an OCC sequence of length 2. In this case, the elements in the OCC sequence are in one-to-one correspondence (or mapping) to the two REs. The mapping rule of the OCC sequence may be mapping first by frequency-domain index in ascending order and then by time-domain index in ascending order, or first by time-domain index in ascending order and then by frequency-domain index in ascending order.

For another example, taking the first reference signal being the CSI-RS as an example, as shown in FIG. 5, one basic resource set includes four REs.

The basic resource set 4-1 occupies four REs corresponding to two consecutive subcarriers on two consecutive symbols. One to four CSI-RS ports can be multiplexed onto the basic resource set 4-1. When one CSI-RS port is multiplexed, an OCC sequence is not required. When two CSI-RS ports are multiplexed, an FD-OCC of length 2 is used on the first and second subcarriers of the first symbol for multiplexing and an FD-OCC of length 2 is used on the first and second subcarriers of the second symbol for multiplexing, or a TD-OCC of length 2 is used on the first and second symbols of the first subcarrier for multiplexing and a TD-OCC of length 2 is used on the first and second symbols of the second subcarrier for multiplexing. When four CSI-RS ports are multiplexed, both an FD-OCC sequence of length 2 and a TD-OCC sequence of length 2 are used for orthogonal multiplexing of the four ports.

The basic resource set 4-2 occupies two consecutive symbols, occupies the first and second subcarriers on the first symbol, and occupies the second and third subcarriers on the second symbol. This pattern is conducive to obtaining frequency-domain diversity gain, and is also beneficial for measurement and processing of time-domain characteristics such as frequency offset. One to four CSI-RS ports can be multiplexed onto the basic resource set 4-2. When one CSI-RS port is multiplexed, an OCC sequence is not required. When two CSI-RS ports are multiplexed, an FD-OCC sequence of length 2 can be used on the first and second subcarriers of the first symbol for multiplexing of the two ports, and an FD-OCC sequence of length 2 can also be used on the second and third subcarriers of the second symbol for multiplexing of the two ports. In this case, the two REs on the second symbol can also be considered as repetition or frequency hopping of the REs on the first symbol. When four CSI-RS ports are multiplexed, an FD-OCC sequence of length 4 can be used on the first and second subcarriers of the first symbol and the second and third subcarriers of the second symbol for multiplexing of the four ports; or an FD-OCC sequence of length 2 can be used on the first and second subcarriers of the first symbol for multiplexing of the four ports, an FD-OCC sequence of length 2 can also be used on the second and third subcarriers of the second symbol for multiplexing of the four ports, and a TD-OCC sequence of length 2 is mapped on the second subcarriers of the first and second symbols to achieve orthogonal multiplexing of the four ports.

The basic resource set 4-3 occupies two consecutive symbols, occupies the first and second subcarriers on the first symbol, and occupies the third and fourth subcarriers on the second symbol. This pattern is conducive to obtaining frequency-domain or time-domain diversity gain, and can also be used to reduce the CSI-RS resource occupancy overheads when the similar measurement effects are achieved. One to four CSI-RS ports can be multiplexed onto the basic resource set 4-3. When one CSI-RS port is multiplexed, an OCC sequence is not required. When two CSI-RS ports are multiplexed, an FD-OCC sequence of length 2 can be used on the first and second subcarriers of the first symbol for multiplexing of the two ports, and an FD-OCC sequence of length 2 can also be used on the third and fourth subcarriers of the second symbol for multiplexing of the two ports. In this case, the two REs on the second symbol can also be considered as repetition or frequency hopping of the REs on the first symbol. When four CSI-RS ports are multiplexed, an FD-OCC sequence of length 4 can be used on the first and second subcarriers of the first symbol and the third and fourth subcarriers of the second symbol for multiplexing of the four ports; or an FD-OCC sequence of length 2 can be used on the first and second subcarriers of the first symbol for multiplexing of the four ports, an FD-OCC sequence of length 2 can also be used on the third and fourth subcarriers of the second symbol for multiplexing of the four ports, and a TD-OCC sequence of length 2 is mapped on the second subcarrier of the first symbol and the third subcarrier of the second symbol to achieve orthogonal multiplexing of the four ports.

The basic resource set 4-4 occupies four consecutive REs on the same symbol. This pattern is suitable for scenarios with small frequency-domain delay and is beneficial for channel measurement in frequency domain. One to four CSI-RS ports can be multiplexed onto the basic resource set 4-4. When one CSI-RS port is multiplexed, an OCC sequence is not required. When two CSI-RS ports are multiplexed, an FD-OCC of length 2 is used on the first and second subcarriers for multiplexing and an FD-OCC of length 2 is used on the third and fourth subcarriers for multiplexing, or an FD-OCC of length 2 is used on the first and third subcarriers for multiplexing and an FD-OCC of length 2 is used on the second and fourth subcarriers for multiplexing. When four CSI-RS ports are multiplexed, an FD-OCC sequence of length 4 is used for multiplexing of the four ports.

The basic resource set 4-5 occupies 4 consecutive REs in time domain on the same subcarrier. This pattern is suitable for scenarios with large delay extension but small mobility (Doppler). One to four CSI-RS ports can be multiplexed onto the basic resource set 4-5. When one CSI-RS port is multiplexed, an OCC sequence is not required. When two CSI-RS ports are multiplexed, a TD-OCC of length 2 is used on the first and second symbols for multiplexing and a TD-OCC of length 2 is used on the third and fourth symbols for multiplexing, or a TD-OCC of length 2 is used on the first and third symbols for multiplexing and a TD-OCC of length 2 is used on the second and fourth symbols for multiplexing. When four CSI-RS ports are multiplexed, a TD-OCC sequence of length 4 is used for multiplexing of the four ports.

The mapping rule of the OCC sequence may be mapping first by frequency-domain index in ascending order and then by time-domain index in ascending order, or first by time-domain index in ascending order and then by frequency-domain index in ascending order.

In addition, one CSI-RS resource can be constructed through one or more types of basic resource sets. For example, the basic resource sets 2-1 and 2-3 can be combined to construct a 4-port CSI-RS resource; and other basic resource sets can also be combined to construct CSI-RS resources with different numbers of ports, which is not described herein again.

In the embodiments of this application, the first reference signal may be determined by the terminal based on first information sent by a network-side device.

The first information may include at least one of the following 3.1 to 3.6:
3.1. a number of ports of the first reference signal;
3.2. at least one basic resource set corresponding to the first reference signal;
3.3. a type of the basic resource set;
3.4. information of a port multiplexed onto the basic resource set;
3.5. information of an OCC sequence corresponding to a port of the first reference signal, the OCC sequence including at least one of an FD-OCC sequence and a TD-OCC sequence; and
3.6. a transmission power of the first reference signal.

In the embodiments of this application, since the first reference signal may be determined by the terminal based on at least one of 3.1 to 3.6 sent by the network-side device, the terminal can determine the first reference signal based on different information, thereby improving the flexibility of the terminal in determining the first reference signal.

In the embodiments of this application, the at least one basic resource set includes at least two basic resource sets.

The at least two basic resource sets may correspond to any one of the following:
a plurality of repetitions (that is, repetition) of a basic resource set;
a first basic resource set binding, the first basic resource set binding including a plurality of basic resource sets mapped on a plurality of consecutive symbols; and
a second basic resource set binding, the second basic resource set binding including a plurality of basic resource sets mapped on a plurality of consecutive physical resource blocks (Physical Resource Block, PRB).

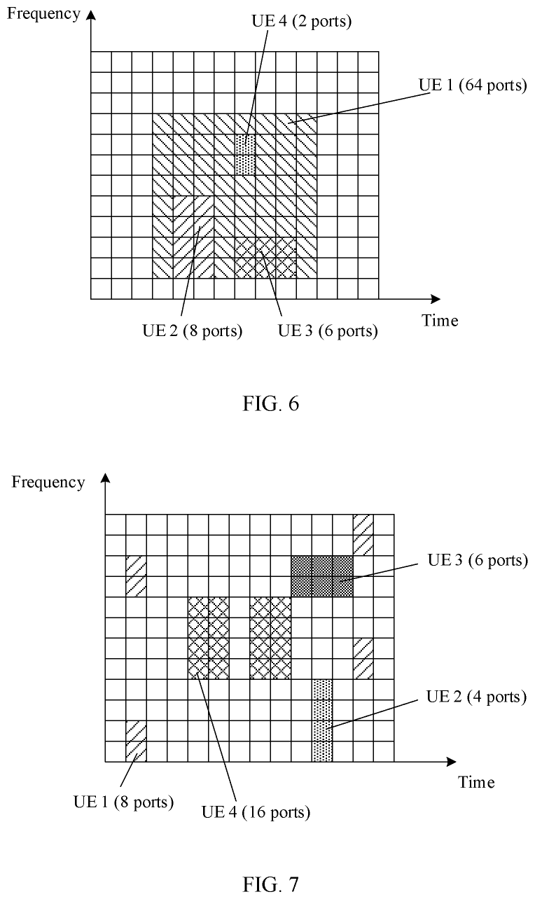

For example, taking the first reference signal being the CSI-RS and the basic resource set being the basic resource set 2-1 in FIG. 4 as an example, two CSI-RS ports are multiplexed onto each basic resource set 2-1 using an FD-OCC sequence of length 2. As shown in FIG. 6, the network side configures a CSI-RS resource #1 for user equipment (User Equipment, UE) 1, which occupies 32 basic resource sets in one RB and has 64 ports; configures a CSI-RS resource #2 for UE 2, which occupies 4 basic resource sets in one RB and has 8 ports; configures a CSI-RS resource #3 for UE 3, which occupies 3 basic resource sets in one RB and has 6 ports; and configures a CSI-RS resource #4 for UE 4, which occupies 1 basic resource set in one RB and has 2 ports. The time-frequency resources occupied by the CSI-RS resources of UE 2, UE 3, and UE 4 are located within the CSI-RS resource of UE 1. At the time-frequency multiplexing positions, a plurality of CSI-RS resources are all transmitted, and different UEs only need to receive the CSI-RS at their corresponding time-frequency positions. Since all CSI-RS resources use the same basic resource set, the plurality of CSI-RS resources multiplex the same time-frequency resources, thereby reducing the overall CSI-RS occupancy overheads in the network.

It should be noted that FIG. 6 is only a schematic diagram of time-frequency resource occupancy in one RB, and the CSI-RS resource may be mapped on a plurality of RBs, which specifically depends on the number of RBs occupied by the CSI-RS resource and its frequency-domain density.

In addition, if it is agreed by default that one basic resource set 2-1 corresponds to two CSI-RS ports, the number of ports of the CSI-RS resource only needs to be determined based on the number of basic resource sets 2-1. When A basic resource sets 2-1 are occupied, the number of ports of the CSI-RS resource is 2*A.

In the embodiments of this application, since the at least two basic resource sets may correspond to the plurality of repetitions of the basic resource set, the first basic resource set binding, or the second basic resource set binding, the composition of the first information can be further enriched, thereby further improving the flexibility in determining the first reference signal based on the first information.

In the embodiments of this application, the number of ports of the first reference signal may be determined based on at least one of the following:
a number of ports multiplexed onto the basic resource set; and
a number of basic resource sets.

For example, taking the first reference signal being the CSI-RS and the number of ports of the first reference signal being determined based on the number of ports multiplexed onto the basic resource set as an example, and assuming that two types of basic resource sets are indicated in total, where one multiplexes X CSI-RS ports and indicates M of such basic resource sets, and the other multiplexes Y CSI-RS ports and indicates L of such basic resource sets, the number of CSI-RS ports is X*M+Y*L; where X, M, Y, and L are all positive integers.

For another example, taking the first reference signal being the CSI-RS and the number of ports of the first reference signal being determined based on the number of basic resource sets as an example, and assuming that it is agreed by default that one basic resource set multiplexes A CSI-RS ports, when B basic resource sets are indicated, the number of CSI-RS ports can be determined as A*B based on the number of basic resource sets; where A and B are both positive integers.

In the embodiments of this application, since the number of ports of the first reference signal may be determined based on at least one of the number of ports multiplexed onto the basic resource set and the number of basic resource sets, the number of ports of the first reference signal can be determined based on different information, thereby improving the flexibility in determining the number of ports of the first reference signal.

In the embodiments of this application, a time-frequency resource position corresponding to the first reference signal may be indicated by a bitmap (that is, bitmap).

In the embodiments of this application, since the time-frequency resource position corresponding to the first reference signal may be indicated by the bitmap, that is, the time-frequency resource position may be indicated by 0 and 1 in the bitmap, it is convenient to flexibly indicate the time-frequency resource position.

In the embodiments of this application, the bitmap may satisfy at least one of the following 4.1 to 4.3:
4.1. an indication range of the bitmap includes at least one frequency-domain element and at least one time-domain element; where
in the embodiments of this application, the at least one frequency-domain element may be at least one PRB, and
in the embodiments of this application, the at least one time-domain element may be at least one slot;
4.2. each bit in the bitmap corresponds to at least one basic resource set; and
4.3. a number of first values in the bitmap is the same as the number of ports of the first reference signal.

In the embodiments of this application, the first value may be 1.

In the embodiments of this application, since the bitmap may satisfy at least one of 4.1 to 4.3, the time-frequency resource position corresponding to the first reference signal can be indicated by the bitmap satisfying different conditions, thereby improving the flexibility in indicating the time-frequency resource position corresponding to the first reference signal.

For example, taking the first reference signal being the CSI-RS and the basic resource set being the basic resource set 2-1 in FIG. 4 as an example, two CSI-RS ports are multiplexed onto each basic resource set 2-1 using an FD-OCC sequence of length 2. The method of indicating the time-frequency resource position of the CSI-RS resource includes:

### Indication Method 1

Indication is performed in the form of a bitmap (the actually occupied basic resource set is represented by 1, and the unoccupied basic resource set is represented by 0), and the range of the bitmap corresponds to at least one of at least one frequency-domain element and at least one time-domain element that are predetermined by default. Taking the range of the bitmap being one RB and one slot as an example, one RB occupies 12 subcarriers, and one slot includes 14 symbols. The time-frequency resource position of the CSI-RS resource corresponding to UE 1 shown in FIG. 7 can be represented by a two-dimensional matrix of 6*14, and the two-dimensional matrix is as follows:

$$[ \begin{matrix}0 & 0 & 0 & 0 & 0 & 0 & 0 & 0 & 0 & 0 & 0 & 0 & 1 & 0 \\ 0 & 1 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 1 & 0 \\ 0 & 0 & 0 & 0 & 0 & 0 & 0 & 0 & 0 & 0 & 0 & 0 & 0 & 0 \\ 0 & 1 & 0 & 0 & 0 & 0 & 0 & 0 & 0 & 0 & 0 & 0 & 0 & 0\end{matrix} ] .$$

It can be seen that the indication method 1 can flexibly indicate any time-frequency resource position, but the overall bitmap overheads are large.

### Indication Method 2

Indication is performed in the form of a bitmap, and the range of the bitmap is related to the actual time-domain position occupied by the CSI-RS resource. When the actual time-domain position occupied by the CSI-RS resource is determined, its bitmap overheads in time domain can be effectively reduced. When the actual time-domain position occupied by the CSI-RS resource is one symbol, the range of the bitmap is one RB and one symbol. The time-frequency resource position of the CSI-RS resource corresponding to UE 2 shown in FIG. 7 can be represented by a one-dimensional vector of 6*1, and the one-dimensional vector is as follows:

$$[ \begin{matrix}0 \\ 0 \\ 0 \\ 0 \\ 1 \\ 1\end{matrix} ] .$$

It can be seen that the indication method 2 can effectively reduce the bitmap overheads in time domain, but the degree of bitmap overhead reduction is related to the actual number of symbols occupied by the CSI-RS resource, and the relationship between the actually occupied symbols and the bitmap needs to be established. For example, when the CSI-RS resource actually occupies two symbols, a two-dimensional matrix of 6*2 needs to be used to represent the time-frequency resource position of the CSI-RS resource, where the first row of the matrix corresponds to the first symbol, and the second row of the matrix corresponds to the second symbol.

### Indication Method 3

Indication is performed in the form of a bitmap, and the range of the bitmap is related to the actual frequency-domain position occupied by the CSI-RS resource. When the actual frequency-domain position occupied by the CSI-RS resource is determined, its bitmap overheads in frequency domain can be effectively reduced. When the actual frequency-domain position occupied by the CSI-RS resource is the bandwidth of one basic resource set, the range of the bitmap is the bandwidth of one basic resource set and 14 symbols. The time-frequency resource position of the CSI-RS resource corresponding to UE 3 shown in FIG. 7 can be represented by a one-dimensional vector of 1*14, and the one-dimensional vector is as follows:
[0 0 0 0 0 0 0 0 0 1 1 1 0 0]

It can be seen that the indication method 3 can effectively reduce the bitmap overheads in frequency domain, but the degree of bitmap overhead reduction is related to the bandwidth actually occupied by the CSI-RS resource, and the relationship between the actually occupied bandwidth and the bitmap needs to be established.

### Indication Method 4

Indication is performed in the form of a bitmap, and the range of the bitmap is related to the actual frequency-domain position and time-domain position occupied by the CSI-RS resource, that is, a combination of the indication methods 2 and 3. Assuming that the range of the bitmap is from the fifth symbol to the ninth symbol and from the first subcarrier to the eighth subcarrier, the time-frequency resource position of the CSI-RS resource corresponding to UE 4 shown in FIG. 7 can be represented by a two-dimensional matrix of 4*5:

$$[ \begin{matrix}1 & 1 & 0 & 1 & 1 \\ 1 & 1 & 0 & 1 & 1 \\ 0 & 0 & 0 & 0 & 0 \\ 0 & 0 & 0 & 0 & 0\end{matrix} ] .$$

In addition, one bit in the bitmap may also represent a set of basic resource sets (that is, including a plurality of basic resource sets). For example, as shown in FIG. 7, the two basic resource sets occupied by UE 2 can be taken as one set for bitmap, and only three bits are required in frequency domain for indication, thereby further reducing the bitmap overheads.

In the embodiments of this application, the information of the port multiplexed onto the basic resource set may include at least one of the following:
a number of ports multiplexed onto the basic resource set; and
an index of the ports multiplexed onto the basic resource set.

In the embodiments of this application, if there are a plurality of basic resource sets, the numbers of ports of the first reference signal actually multiplexed onto any two of the plurality of basic resource sets can be the same or different.

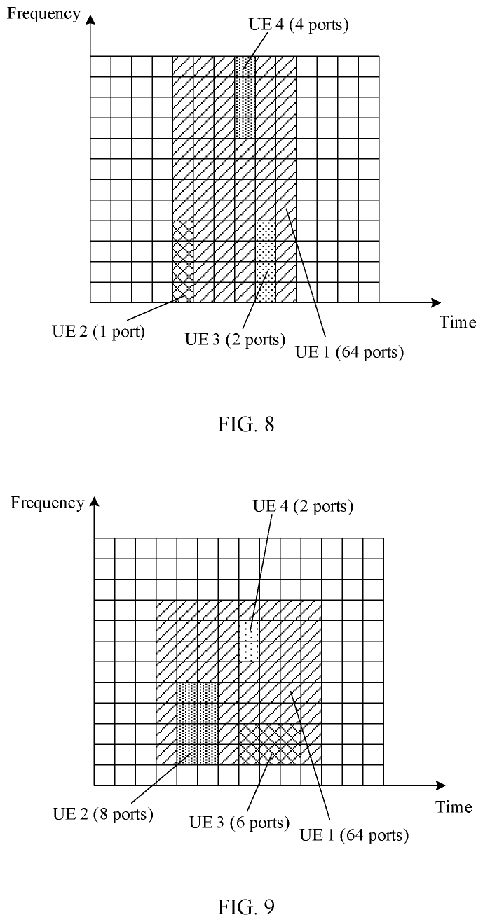

For example, taking the first reference signal being the CSI-RS and the basic resource set being the basic resource set 4-4 in FIG. 5 as an example, up to four CSI-RS ports can be multiplexed onto each basic resource set 4-4 using an FD-OCC sequence of length 4. As shown in FIG. 8, the network side configures a CSI-RS resource #1 for UE 1, which occupies 16 basic resource sets in one RB and has 64 ports; configures a CSI-RS resource #2 for UE 2, which occupies 1 basic resource set in one RB and has 1 port; configures a CSI-RS resource #3 for UE 3, which occupies 1 basic resource set in one RB and has 2 ports; and configures a CSI-RS resource #4 for UE 4, which occupies 1 basic resource set in one RB and has 4 ports. Although UE 2 (CSI-RS resource #2), UE 3 (CSI-RS resource #3), and UE 4 (CSI-RS resource #4) all occupy one basic resource set, one basic resource set in different CSI-RS resources may correspond to different numbers of CSI-RS ports (the number of CSI-RS ports corresponding to one basic resource set may be configured by the network side or agreed by default in the protocol).

For UE 1 (CSI-RS resource #1), four CSI-RS ports are multiplexed onto each corresponding basic resource set using an FD-OCC sequence of length 4; for UE 2 (CSI-RS resource #2), one CSI-RS port is multiplexed onto each corresponding basic resource set using an FD-OCC sequence of length 4, and UE 2 receives the CSI-RS based on the corresponding FD-OCC sequence of length 4; for UE 3 (CSI-RS resource #3), two CSI-RS ports are multiplexed onto each corresponding basic resource set using an FD-OCC sequence of length 4, and UE 3 receives the CSI-RS based on the corresponding two FD-OCC sequences of length 4; and for UE 4 (CSI-RS resource #4), four CSI-RS ports are multiplexed onto each corresponding basic resource set using an FD-OCC sequence of length 4, and UE 4 receives the CSI-RS based on the corresponding four FD-OCC sequences of length 4.

It can be seen that the number of ports of one CSI-RS resource is not only related to the number of basic resource sets, but also to the actual number of ports mapped on the basic resource set or the FD-OCC sequence (including the number). Even if the same time-frequency resources are occupied, the numbers of CSI-RS ports corresponding to different CSI-RS resources may be different, thereby achieving flexible CSI-RS resource configuration and occupancy, and reducing the overall CSI-RS resource occupancy overheads. Different CSI-RS resources only need to receive the CSI-RS on the corresponding time-frequency resources based on their corresponding FD-OCC sequences.

It should be noted that FIG. 8 is only a schematic diagram of time-frequency resource occupancy in one RB, and the CSI-RS resource may be mapped on a plurality of RBs, for example, when the CSI-RS resource is mapped on a plurality of RBs, the time-domain resources mapped in each RB are as shown in FIG. 8; which specifically depends on the number of RBs occupied by the CSI-RS resource and its frequency-domain density.

In the embodiments of this application, since the information of the port multiplexed onto the basic resource set may include at least one of the number and index of the ports multiplexed onto the basic resource set, the multiplexed ports can be flexibly determined based on at least one of the number and the index.

In the embodiments of this application, the information of the OCC sequence corresponding to the port of the first reference signal may include at least one of the following 5.1 to 5.3:
5.1. an OCC sequence corresponding to a port multiplexed onto a basic resource set that corresponds to the first reference signal;
5.2. an assumed length (that is, despreading length) for demodulating an OCC sequence; and
5.3. a length of an OCC sequence.

In the embodiments of this application, if a plurality of basic resource sets correspond to the first reference signal, OCC sequences or numbers of sequences corresponding to ports of the first reference signal actually multiplexed onto any two of the plurality of basic resource sets may be the same or different.

For example, taking the information of the OCC sequence corresponding to the port of the first reference signal including 5.2 as an example, when up to four ports are multiplexed onto a given basic resource set using an OCC sequence of length 4, if the network-side device indicates two ports to the terminal, the terminal can demodulate the OCC sequence based on the assumed length of 2 (that is, despreading length).

In the embodiments of this application, since the information of the OCC sequence corresponding to the port of the first reference signal may include at least one of 5.1 to 5.3, the composition of the first information can be further enriched, thereby further improving the flexibility in determining the first reference signal based on the first information.

In the embodiments of this application, the transmission power may be associated with any one of the following 6.1 to 6.6:
6.1. a transmit power of a signal (or channel) other than the first reference signal;
6.2. a reference power agreed by default;
6.3. a reference power configured by the network-side device;
6.4. a minimum power of a first basic resource set;
6.5. a maximum power of a first basic resource set; and
6.6. an average power of a first basic resource set; where
the first basic resource set is at least one basic resource set within a predetermined range.

In the embodiments of this application, the transmission powers on different basic resource sets may be the same or different.

In the embodiments of this application, the transmission power may be an offset (that is, offset) based on any one of 6.1 to 6.6.

In the embodiments of this application, the another signal (or channel) may be a synchronization channel, a data channel, a control channel, or the like.

In the embodiments of this application, since the transmission power may be associated with any one of 6.1 to 6.6, the transmission power can be determined based on different associated information, thereby improving the flexibility in determining the transmission power.

In the embodiments of this application, the transmission power may correspond to one or more of the basic resource sets.

In the embodiments of this application, when the transmission power corresponds to one basic resource set, if the network indicates P power coefficients, they correspond to P basic resource sets, where P is a positive integer.

In the embodiments of this application, when the transmission power corresponds to a plurality of basic resource sets, for example, Q basic resource sets, where Q is an integer greater than or equal to 2, if the network indicates P power coefficients, they correspond to P*Q basic resource sets, where each power coefficient corresponds to Q basic resource sets.

In the embodiments of this application, since the transmission power may correspond to one or more of the basic resource sets, flexible correspondence between the transmission power and the number of basic resource sets can be achieved.

In the embodiments of this application, the transmission power corresponding to the basic resource set may be determined in any one of the following manners:
based on a bitmap; and
based on mapping in a specific correspondence order.

In the embodiments of this application, the transmission power may be mapped with one or more of the basic resource sets based on the bitmap.

In the embodiments of this application, the specific correspondence order may be the order of code domain, frequency domain, and time domain, that is, mapping at least one power parameter to at least one basic resource set by OCC sequence in ascending order, frequency-domain position in ascending order, and then time-domain position in ascending order.

In the embodiments of this application, since the transmission power corresponding to the basic resource set may be determined based on the bitmap or the mapping in the specific correspondence order, the flexibility in determining the transmission power corresponding to the basic resource set can be improved.

For example, taking the first reference signal being the CSI-RS and the basic resource set being the basic resource set 2-1 in FIG. 4 as an example, two CSI-RS ports are multiplexed onto each basic resource set 2-1 using an FD-OCC sequence of length 2. As shown in FIG. 9, a CSI-RS resource #1 is configured for UE 1, which occupies 32 basic resource sets in one RB and has 64 ports; a CSI-RS resource #2 is configured for UE 2, which occupies 4 basic resource sets in one RB and has 8 ports; a CSI-RS resource #3 is configured for UE 3, which occupies 3 basic resource sets in one RB and has 6 ports; and a CSI-RS resource #4 is configured for UE 4, which occupies 1 basic resource set in one RB and has 2 ports.

In this case, the transmission powers of the CSI-RS resources #2, #3, and #4 may be different, for example, the network side configures different transmission powers for the CSI-RS resources #2, #3, and #4. The power may be directly configured or may be reflected through a power offset with another signal or channel. For the CSI-RS resource #1, a plurality of different transmission powers appear at its corresponding time-frequency positions, that is, transmission needs to be performed according to the transmission powers corresponding to the CSI-RS resources #2, #3, and #4 at the time-frequency positions overlapping with the CSI-RS resources #2, #3, and #4, thereby achieving multiplexing of the time-frequency positions and powers of the plurality of CSI-RS resources. For the CSI-RS resource #1, UE 1 needs to be informed of the transmission powers at the time-frequency positions overlapping with the CSI-RS resources #2, #3, and #4, so that UE 1 can correctly perform measurement at the receiving end. In this case, one or more basic resource sets can be used as the granularity for transmission power configuration, so that UE 1 can learn the transmission powers at different time-frequency positions.

In the port multiplexing method provided in the embodiments of this application, the terminal can receive the first reference signal including one or more types of basic resource sets, and the port of the first reference signal is multiplexed onto one or more of the basic resource sets, so that a plurality of reference signals with different numbers of ports can be multiplexed onto the same time-frequency resource, thereby reducing the overall reference signal resource overheads in the network.

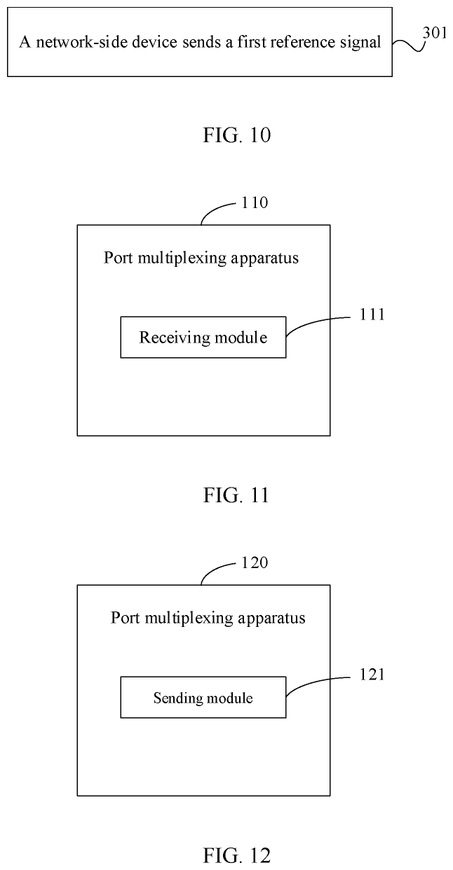

An embodiment of this application provides another port multiplexing method. FIG. 10 is a flowchart of the port multiplexing method according to the embodiment of this application. As shown in FIG. 10, the port multiplexing method according to the embodiment of this application may include step 301 below.

Step 301: A network-side device sends a first reference signal.

The first reference signal includes one or more types of basic resource sets, each type of the basic resource sets includes one or more resource elements, and a port of the first reference signal is multiplexed onto one or more of the basic resource sets.

In the embodiments of this application, each of the one or more types of the basic resource sets includes a plurality of resource elements.

The plurality of resource elements may include at least one of the following:
a plurality of resource elements that are consecutive or non-consecutive in frequency domain at a same time-domain position;
a plurality of resource elements that are consecutive or non-consecutive in time domain at a same frequency-domain position;
a plurality of resource elements occupying at least one time-domain position; and
a plurality of frequency-domain elements occupying at least one frequency-domain position.

In the embodiments of this application, the port of the first reference signal may be multiplexed in at least one of the following manners:
multiplexing on one of the basic resource sets using an FD-OCC sequence;
multiplexing on one of the basic resource sets using a TD-OCC sequence;
multiplexing among the plurality of basic resource sets using TDM; and
multiplexing among the plurality of basic resource sets using FDM.

In the embodiments of this application, each type of the basic resource sets includes a plurality of resource elements, and a length of a first sequence may be related to a number of first resource elements.

The first sequence is the FD-OCC sequence, and the first resource elements are a plurality of resource elements in frequency domain; or the first sequence is the TD-OCC sequence, and the first resource elements are a plurality of resource elements in time domain.

In the port multiplexing method provided in the embodiments of this application, the network-side device can send the first reference signal including one or more types of basic resource sets, and the port of the first reference signal is multiplexed onto one or more of the basic resource sets, so that a plurality of reference signals with different numbers of ports can be multiplexed onto the same time-frequency resource, thereby reducing the overall reference signal resource overheads in the network.

In the embodiments of this application, the port multiplexing method provided in the embodiments of this application may further include step 302 below.

Step 302: The network-side device sends first information.

The first information is used for a terminal to determine the first reference signal, and the first information may include at least one of the following:
a number of ports of the first reference signal;
at least one basic resource set corresponding to the first reference signal;
a type of the basic resource set;
information of a port multiplexed onto the basic resource set;
information of an OCC sequence corresponding to a port of the first reference signal, the OCC sequence including at least one of an FD-OCC sequence and a TD-OCC sequence; and
a transmission power of the first reference signal.

It should be noted that an order for performing step 302 and step 301 is not limited in the embodiments of this application, that is, step 301 may be performed before step 302, step 302 may be performed before step 301, or step 301 and step 302 may be performed at the same time.

In the embodiments of this application, the at least one basic resource set includes at least two basic resource sets.

The at least two basic resource sets may correspond to any one of the following:
a plurality of repetitions of a basic resource set;
a first basic resource set binding, the first basic resource set binding including a plurality of basic resource sets mapped on a plurality of consecutive symbols; and
a second basic resource set binding, the second basic resource set binding including a plurality of basic resource sets mapped on a plurality of consecutive PRBs.

In the embodiments of this application, the number of ports of the first reference signal may be determined based on at least one of the following:
a number of ports multiplexed onto the basic resource set; and
a number of basic resource sets.

In the embodiments of this application, a time-frequency resource position corresponding to the first reference signal may be indicated by a bitmap.

In the embodiments of this application, the bitmap may satisfy at least one of the following:
an indication range of the bitmap includes at least one frequency-domain element and at least one time-domain element;
each bit in the bitmap corresponds to at least one basic resource set; and
a number of first values in the bitmap is the same as the number of ports of the first reference signal.

In the embodiments of this application, the information of the port multiplexed onto the basic resource set may include at least one of the following:
a number of ports multiplexed onto the basic resource set; and
an index of the ports multiplexed onto the basic resource set.

In the embodiments of this application, the information of the OCC sequence corresponding to the port of the first reference signal may include at least one of the following:
an OCC sequence corresponding to a port multiplexed onto a basic resource set that corresponds to the first reference signal;
an assumed length for demodulating an OCC sequence; and
a length of an OCC sequence.

In the embodiments of this application, the transmission power may be associated with any one of the following:
a transmit power of a signal other than the first reference signal;
a reference power agreed by default;
a reference power configured by the network-side device;
a minimum power of a first basic resource set;
a maximum power of a first basic resource set; and
an average power of a first basic resource set; where
the first basic resource set is at least one basic resource set within a predetermined range.

In the embodiments of this application, the transmission power may correspond to one or more of the basic resource sets.

In the embodiments of this application, the transmission power corresponding to the basic resource set may be determined in any one of the following manners:
based on a bitmap; and
based on mapping in a specific correspondence order.

For details about other descriptions of the embodiments of this application and the technical effects that the technical features can achieve, reference may be made to the relevant descriptions in the foregoing method embodiment on the terminal side. To avoid repetition, details are not described herein again.

The port multiplexing method provided in the embodiments of this application can be performed by a port multiplexing apparatus. In the embodiments of this application, the port multiplexing method being performed by the port multiplexing apparatus is used as an example to describe the port multiplexing apparatus provided in the embodiments of this application.

With reference to FIG. 11, an embodiment of this application provides a port multiplexing apparatus 110. The port multiplexing apparatus 110 may include a receiving module 111.

The receiving module 111 can be configured to receive a first reference signal; where the first reference signal includes one or more types of basic resource sets, each type of the basic resource sets includes one or more resource elements, and a port of the first reference signal is multiplexed onto one or more of the basic resource sets.

In a possible implementation, each of the one or more types of the basic resource sets may include a plurality of resource elements. The plurality of resource elements include at least one of the following: a plurality of resource elements that are consecutive or non-consecutive in frequency domain at a same time-domain position; a plurality of resource elements that are consecutive or non-consecutive in time domain at a same frequency-domain position; a plurality of resource elements occupying at least one time-domain position; and a plurality of frequency-domain elements occupying at least one frequency-domain position.

In a possible implementation, the port of the first reference signal may be multiplexed in at least one of the following manners: multiplexing on one of the basic resource sets using an FD-OCC sequence; multiplexing on one of the basic resource sets using a TD-OCC sequence; multiplexing among the plurality of basic resource sets using TDM; and multiplexing among the plurality of basic resource sets using FDM.

In a possible implementation, each type of the basic resource sets may include a plurality of resource elements. A length of a first sequence is related to a number of first resource elements; where the first sequence is the FD-OCC sequence, and the first resource elements are a plurality of resource elements in frequency domain; or the first sequence is the TD-OCC sequence, and the first resource elements are a plurality of resource elements in time domain.

In a possible implementation, the first reference signal may be determined by the terminal based on first information sent by a network-side device. The first information includes at least one of the following: a number of ports of the first reference signal; at least one basic resource set corresponding to the first reference signal; a type of the basic resource set; information of a port multiplexed onto the basic resource set; information of an OCC sequence corresponding to a port of the first reference signal, the OCC sequence including at least one of an FD-OCC sequence and a TD-OCC sequence; and a transmission power of the first reference signal.

In a possible implementation, the at least one basic resource set may include at least two basic resource sets. The at least two basic resource sets correspond to any one of the following: a plurality of repetitions of a basic resource set; a first basic resource set binding, the first basic resource set binding including a plurality of basic resource sets mapped on a plurality of consecutive symbols; and a second basic resource set binding, the second basic resource set binding including a plurality of basic resource sets mapped on a plurality of consecutive PRBs.

In a possible implementation, the number of ports of the first reference signal may be determined based on at least one of the following: a number of ports multiplexed onto the basic resource set; and a number of basic resource sets.

In a possible implementation, a time-frequency resource position corresponding to the first reference signal may be indicated by a bitmap.

In a possible implementation, the bitmap may satisfy at least one of the following: an indication range of the bitmap includes at least one frequency-domain element and at least one time-domain element; each bit in the bitmap corresponds to at least one basic resource set; and a number of first values in the bitmap is the same as the number of ports of the first reference signal.

In a possible implementation, the information of the port multiplexed onto the basic resource set may include at least one of the following: a number of ports multiplexed onto the basic resource set; and an index of the ports multiplexed onto the basic resource set.

In a possible implementation, the information of the OCC sequence corresponding to the port of the first reference signal may include at least one of the following: an OCC sequence corresponding to a port multiplexed onto a basic resource set that corresponds to the first reference signal; an assumed length for demodulating an OCC sequence; and a length of an OCC sequence.

In a possible implementation, the transmission power may be associated with any one of the following: a transmit power of a signal other than the first reference signal; a reference power agreed by default; a reference power configured by the network-side device; a minimum power of a first basic resource set; a maximum power of a first basic resource set; and an average power of a first basic resource set. The first basic resource set is at least one basic resource set within a predetermined range.

In a possible implementation, the transmission power may correspond to one or more of the basic resource sets.

In a possible implementation, the transmission power corresponding to the basic resource set may be determined in any one of the following manners: based on a bitmap; and based on mapping in a specific correspondence order.

In the port multiplexing apparatus provided in the embodiments of this application, the port multiplexing apparatus can receive the first reference signal including one or more types of basic resource sets, and the port of the first reference signal is multiplexed onto one or more of the basic resource sets, so that a plurality of reference signals with different numbers of ports can be multiplexed onto the same time-frequency resource, thereby reducing the overall reference signal resource overheads in the network.

The port multiplexing apparatus in the embodiments of this application may be an electronic device, for example, an electronic device with an operating system, or may be a component in an electronic device, for example, an integrated circuit or a chip. The electronic device may be a terminal. For example, the terminal may include but is not limited to the types of the terminal 11 listed above, which is not specifically limited in the embodiments of this application.

The port multiplexing apparatus provided in the embodiments of this application can implement the processes implemented in the foregoing method embodiment on the terminal side, with the same technical effects achieved. To avoid repetition, details are not described herein again.

With reference to FIG. 12, an embodiment of this application provides another port multiplexing apparatus 120. The port multiplexing apparatus 120 may include a sending module 121.

The sending module 121 can be configured to send a first reference signal; where the first reference signal includes one or more types of basic resource sets, each type of the basic resource sets includes one or more resource elements, and a port of the first reference signal is multiplexed onto one or more of the basic resource sets.

In a possible implementation, each of the one or more types of the basic resource sets may include a plurality of resource elements. The plurality of resource elements include at least one of the following: a plurality of resource elements that are consecutive or non-consecutive in frequency domain at a same time-domain position; a plurality of resource elements that are consecutive or non-consecutive in time domain at a same frequency-domain position; a plurality of resource elements occupying at least one time-domain position; and a plurality of frequency-domain elements occupying at least one frequency-domain position.

In a possible implementation, the port of the first reference signal may be multiplexed in at least one of the following manners: multiplexing on one of the basic resource sets using an FD-OCC sequence; multiplexing on one of the basic resource sets using a TD-OCC sequence; multiplexing among the plurality of basic resource sets using TDM; and multiplexing among the plurality of basic resource sets using FDM.

In a possible implementation, each type of the basic resource sets may include a plurality of resource elements. A length of a first sequence is related to a number of first resource elements; where the first sequence is the FD-OCC sequence, and the first resource elements are a plurality of resource elements in frequency domain; or the first sequence is the TD-OCC sequence, and the first resource elements are a plurality of resource elements in time domain.

In a possible implementation, the sending module 121 is further configured to send first information, the first information being used for a terminal to determine the first reference signal. The first information includes at least one of the following: a number of ports of the first reference signal; at least one basic resource set corresponding to the first reference signal; a type of the basic resource set; information of a port multiplexed onto the basic resource set; information of an OCC sequence corresponding to a port of the first reference signal, the OCC sequence including at least one of an FD-OCC sequence and a TD-OCC sequence; and a transmission power of the first reference signal.

In a possible implementation, the at least one basic resource set may include at least two basic resource sets. The at least two basic resource sets correspond to any one of the following: a plurality of repetitions of a basic resource set; a first basic resource set binding, the first basic resource set binding including a plurality of basic resource sets mapped on a plurality of consecutive symbols; and a second basic resource set binding, the second basic resource set binding including a plurality of basic resource sets mapped on a plurality of consecutive PRBs.

In a possible implementation, the number of ports of the first reference signal may be determined based on at least one of the following: a number of ports multiplexed onto the basic resource set; and a number of basic resource sets.

In a possible implementation, a time-frequency resource position corresponding to the first reference signal may be indicated by a bitmap.

In a possible implementation, the bitmap may satisfy at least one of the following: an indication range of the bitmap includes at least one frequency-domain element and at least one time-domain element; each bit in the bitmap corresponds to at least one basic resource set; and a number of first values in the bitmap is the same as the number of ports of the first reference signal.

In a possible implementation, the information of the port multiplexed onto the basic resource set may include at least one of the following: a number of ports multiplexed onto the basic resource set; and an index of the ports multiplexed onto the basic resource set.

In a possible implementation, the information of the OCC sequence corresponding to the port of the first reference signal may include at least one of the following: an OCC sequence corresponding to a port multiplexed onto a basic resource set that corresponds to the first reference signal; an assumed length for demodulating an OCC sequence; and a length of an OCC sequence.

In a possible implementation, the transmission power may be associated with any one of the following: a transmit power of a signal other than the first reference signal; a reference power agreed by default; a reference power configured by the network-side device; a minimum power of a first basic resource set; a maximum power of a first basic resource set; and an average power of a first basic resource set. The first basic resource set is at least one basic resource set within a predetermined range.

In a possible implementation, the transmission power may correspond to one or more of the basic resource sets.

In a possible implementation, the transmission power corresponding to the basic resource set may be determined in any one of the following manners: based on a bitmap; and based on mapping in a specific correspondence order.

In the port multiplexing apparatus provided in the embodiments of this application, the port multiplexing apparatus can send the first reference signal including one or more types of basic resource sets, and the port of the first reference signal is multiplexed onto one or more of the basic resource sets, so that a plurality of reference signals with different numbers of ports can be multiplexed onto the same time-frequency resource, thereby reducing the overall reference signal resource overheads in the network.

The port multiplexing apparatus in the embodiments of this application may be an electronic device, for example, an electronic device with an operating system, or may be a component in an electronic device, for example, an integrated circuit or a chip. The electronic device may be other devices than terminals. For example, the other devices may be servers, network attached storage (Network Attached Storage, NAS), or the like, which are not specifically limited in the embodiments of this application.

The port multiplexing apparatus provided in the embodiments of this application can implement the processes implemented in the foregoing method embodiment of the network-side device, with the same technical effects achieved. To avoid repetition, details are not described herein again.

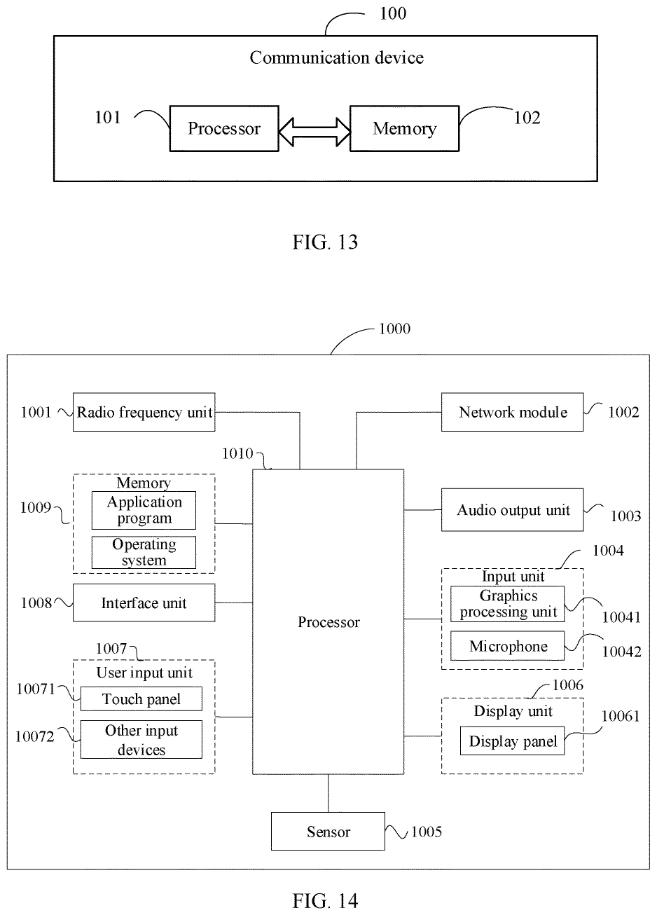

As shown in FIG. 13, an embodiment of this application further provides a communication device 100 including a processor 101 and a memory 102. The memory 102 stores a program or instructions capable of running on the processor 101. For example, in a case that the communication device 100 is a terminal, when the program or instructions are executed by the processor 101, the steps of the foregoing method embodiment on the terminal side are implemented, with the same technical effects achieved. In a case that the communication device 100 is a network-side device, when the program or instructions are executed by the processor 101, the steps of the foregoing method embodiment of the network-side device are implemented, with the same technical effects achieved. To avoid repetition, details are not described herein again.

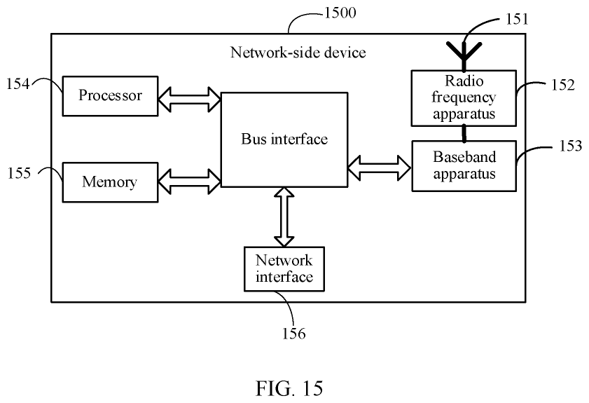

An embodiment of this application further provides a terminal including a processor and a communication interface. The communication interface is coupled to the processor, and the processor is configured to run a program or instructions to implement the steps of the foregoing method embodiment on the terminal side. The communication interface is configured to receive a first reference signal; where the first reference signal includes one or more types of basic resource sets, each type of the basic resource sets includes one or more resource elements, and a port of the first reference signal is multiplexed onto one or more of the basic resource sets. This terminal embodiment corresponds to the foregoing method embodiment on the terminal side. All processes and implementations in the foregoing method embodiment are applicable to this terminal embodiment, with the same technical effects achieved. Specifically, FIG. 14 is a schematic diagram of a hardware structure of a terminal implementing the embodiments of this application.

The terminal 1000 includes but is not limited to at least some of these components: a radio frequency unit 1001, a network module 1002, an audio output unit 1003, an input unit 1004, a sensor 1005, a display unit 1006, a user input unit 1007, an interface unit 1008, a memory 1009, and a processor 1010.

Persons skilled in the art can understand that the terminal 1000 may further include a power supply (for example, a battery) for supplying power to the components. The power supply may be logically connected to the processor 1010 via a power management system, so that functions such as charge management, discharge management, and power consumption management are implemented via the power management system. The terminal structure shown in FIG. 14 does not constitute any limitation on the terminal. The terminal may include more or fewer components than shown in the figure, or combine some of the components, or arrange the components differently. Details are not described herein again.

It should be understood that in the embodiments of this application, the input unit 1004 may include a graphics processing unit (Graphics Processing Unit, GPU) 10041 and a microphone 10042. The graphics processing unit 10041 processes image data of a static picture or a video that is obtained by an image capture apparatus (for example, a camera) in an image capture mode or a video capture mode. The display unit 1006 may include a display panel 10061. The display panel 10061 may be configured in a form of a liquid crystal display, an organic light-emitting diode display, or the like. The user input unit 1007 includes at least one of a touch panel 10071 and other input devices 10072. The touch panel 10071 is also referred to as a touchscreen. The touch panel 10071 may include two parts: a touch detection apparatus and a touch controller. The other input devices 10072 may include but are not limited to a physical keyboard, a function button (for example, a volume control button or an on/off button), a trackball, a mouse, and a joystick. Details are not described herein.

In an embodiment of this application, the radio frequency unit 1001 receives downlink data from a network-side device and sends the data to the processor 1010 for processing; and the radio frequency unit 1001 can additionally send uplink data to the network-side device. Generally, the radio frequency unit 1001 includes but is not limited to an antenna, an amplifier, a transceiver, a coupler, a low noise amplifier, and a duplexer.

The memory 1009 may be configured to store a software program or instructions and various data. The memory 1009 may mainly include a first storage area for storing programs or instructions and a second storage area for storing data. The first storage area may store an operating system, an application program or instructions required by at least one function (for example, a sound playback function or an image playback function), and the like. Additionally, the memory 1009 may be a volatile memory or a non-volatile memory. The non-volatile memory may be a Read-Only Memory (ROM), a Programmable Read-Only Memory (PROM), an Erasable Programmable Read-Only Memory (EPROM), an Electrically Erasable Programmable Read-Only Memory (EEPROM), or a Flash Memory. The volatile memory may be a Random Access Memory (RAM), a Static Random Access Memory (SRAM), a Dynamic Random Access Memory (DRAM), a Synchronous Dynamic Random Access Memory (SDRAM), a Double Data Rate Synchronous Dynamic Random Access Memory (DDR SDRAM), an Enhanced Synchronous Dynamic Random Access Memory (ESDRAM), a Synchronous Link Dynamic Random Access Memory (SLDRAM), or a Direct Rambus Random Access Memory (DRRAM). The memory 1009 in the embodiments of this application includes but is not limited to these and any other applicable types of memories.

The processor 1010 may include one or more processing units. In some embodiments, the processor 1010 integrates an application processor and a modem processor. The application processor primarily processes operations involving an operating system, user interface, application program, and the like. The modem processor primarily processes radio communication signals, for example, being a baseband processor. It can be understood that the modem processor may alternatively be not integrated into the processor 1010.

The radio frequency unit 1001 can be configured to receive a first reference signal; where the first reference signal includes one or more types of basic resource sets, each type of the basic resource sets includes one or more resource elements, and a port of the first reference signal is multiplexed onto one or more of the basic resource sets.

In a possible implementation, each of the one or more types of the basic resource sets may include a plurality of resource elements. The plurality of resource elements include at least one of the following: a plurality of resource elements that are consecutive or non-consecutive in frequency domain at a same time-domain position; a plurality of resource elements that are consecutive or non-consecutive in time domain at a same frequency-domain position; a plurality of resource elements occupying at least one time-domain position; and a plurality of frequency-domain elements occupying at least one frequency-domain position.

In a possible implementation, the port of the first reference signal may be multiplexed in at least one of the following manners: multiplexing on one of the basic resource sets using an FD-OCC sequence; multiplexing on one of the basic resource sets using a TD-OCC sequence; multiplexing among the plurality of basic resource sets using TDM; and multiplexing among the plurality of basic resource sets using FDM.

In a possible implementation, each type of the basic resource sets may include a plurality of resource elements. A length of a first sequence is related to a number of first resource elements; where the first sequence is the FD-OCC sequence, and the first resource elements are a plurality of resource elements in frequency domain; or the first sequence is the TD-OCC sequence, and the first resource elements are a plurality of resource elements in time domain.

In a possible implementation, the first reference signal may be determined by the terminal 1000 based on first information sent by the network-side device. The first information includes at least one of the following: a number of ports of the first reference signal; at least one basic resource set corresponding to the first reference signal; a type of the basic resource set; information of a port multiplexed onto the basic resource set; information of an OCC sequence corresponding to a port of the first reference signal, the OCC sequence including at least one of an FD-OCC sequence and a TD-OCC sequence; and a transmission power of the first reference signal.

In a possible implementation, the at least one basic resource set may include at least two basic resource sets. The at least two basic resource sets correspond to any one of the following: a plurality of repetitions of a basic resource set; a first basic resource set binding, the first basic resource set binding including a plurality of basic resource sets mapped on a plurality of consecutive symbols; and a second basic resource set binding, the second basic resource set binding including a plurality of basic resource sets mapped on a plurality of consecutive PRBs.

In a possible implementation, the number of ports of the first reference signal may be determined based on at least one of the following: a number of ports multiplexed onto the basic resource set; and a number of basic resource sets.

In a possible implementation, a time-frequency resource position corresponding to the first reference signal may be indicated by a bitmap.

In a possible implementation, the bitmap may satisfy at least one of the following: an indication range of the bitmap includes at least one frequency-domain element and at least one time-domain element; each bit in the bitmap corresponds to at least one basic resource set; and a number of first values in the bitmap is the same as the number of ports of the first reference signal.

In a possible implementation, the information of the port multiplexed onto the basic resource set may include at least one of the following: a number of ports multiplexed onto the basic resource set; and an index of the ports multiplexed onto the basic resource set.

In a possible implementation, the information of the OCC sequence corresponding to the port of the first reference signal may include at least one of the following: an OCC sequence corresponding to a port multiplexed onto a basic resource set that corresponds to the first reference signal; an assumed length for demodulating an OCC sequence; and a length of an OCC sequence.

In a possible implementation, the transmission power may be associated with any one of the following: a transmit power of a signal other than the first reference signal; a reference power agreed by default; a reference power configured by the network-side device; a minimum power of a first basic resource set; a maximum power of a first basic resource set; and an average power of a first basic resource set. The first basic resource set is at least one basic resource set within a predetermined range.

In a possible implementation, the transmission power may correspond to one or more of the basic resource sets.

In a possible implementation, the transmission power corresponding to the basic resource set may be determined in any one of the following manners: based on a bitmap; and based on mapping in a specific correspondence order.

In the terminal provided in the embodiments of this application, the terminal can receive the first reference signal including one or more types of basic resource sets, and the port of the first reference signal is multiplexed onto one or more of the basic resource sets, so that a plurality of reference signals with different numbers of ports can be multiplexed onto the same time-frequency resource, thereby reducing the overall reference signal resource overheads in the network.

It can be understood that for the processes of the implementations mentioned in this embodiment, reference may be made to the relevant descriptions in the foregoing method embodiment on the terminal side, with the same or corresponding technical effects achieved. To avoid repetition, details are not described herein again.

An embodiment of this application further provides a network-side device including a processor and a communication interface. The communication interface is coupled to the processor, and the processor is configured to run a program or instructions to implement the steps of the foregoing method embodiment of the network-side device. The communication interface is configured to send a first reference signal; where the first reference signal includes one or more types of basic resource sets, each type of the basic resource sets includes one or more resource elements, and a port of the first reference signal is multiplexed onto one or more of the basic resource sets. This network-side device embodiment corresponds to the foregoing method embodiment of the network-side device. All processes and implementations in the foregoing method embodiment are applicable to this network-side device embodiment, with the same technical effects achieved.

Specifically, an embodiment of this application further provides a network-side device. As shown in FIG. 15, the network-side device 1500 includes an antenna 151, a radio frequency apparatus 152, a baseband apparatus 153, a processor 154, and a memory 155. The antenna 151 is connected to the radio frequency apparatus 152. In an uplink direction, the radio frequency apparatus 152 receives information by using the antenna 151 and transmits the received information to the baseband apparatus 153 for processing. In a downlink direction, the baseband apparatus 153 processes information to be sent, and transmits the information to the radio frequency apparatus 152; and the radio frequency apparatus 152 processes the received information and then transmits the information by using the antenna 151.

The method performed by the network-side device in the foregoing embodiment may be implemented in the baseband apparatus 153, and the baseband apparatus 153 includes a baseband processor.

The baseband apparatus 153 may include, for example, at least one baseband processing unit, where a plurality of chips are disposed on the baseband processing unit. As shown in FIG. 15, one of the chips is, for example, a baseband processor, connected to the memory 155 through a bus interface, to invoke a program in the memory 155 to perform the operations of the network device shown in the foregoing method embodiment.

The network-side device may further include a network interface 156, where the interface is, for example, a common public radio interface (Common Public Radio Interface, CPRI).

Specifically, the network-side device 1500 in this embodiment of this application further includes instructions or a program stored in the memory 155 and capable of running on the processor 154. The processor 154 invokes the instructions or program in the memory 155 to perform the method performed by the modules shown in FIG. 12, with the same technical effects achieved. To avoid repetition, details are not described herein again.

The radio frequency apparatus 152 can be configured to send a first reference signal; where the first reference signal includes one or more types of basic resource sets, each type of the basic resource sets includes one or more resource elements, and a port of the first reference signal is multiplexed onto one or more of the basic resource sets.

In a possible implementation, each of the one or more types of the basic resource sets may include a plurality of resource elements. The plurality of resource elements include at least one of the following: a plurality of resource elements that are consecutive or non-consecutive in frequency domain at a same time-domain position; a plurality of resource elements that are consecutive or non-consecutive in time domain at a same frequency-domain position; a plurality of resource elements occupying at least one time-domain position; and a plurality of frequency-domain elements occupying at least one frequency-domain position.

In a possible implementation, the port of the first reference signal may be multiplexed in at least one of the following manners: multiplexing on one of the basic resource sets using an FD-OCC sequence; multiplexing on one of the basic resource sets using a TD-OCC sequence; multiplexing among the plurality of basic resource sets using TDM; and multiplexing among the plurality of basic resource sets using FDM.

In a possible implementation, each type of the basic resource sets may include a plurality of resource elements. A length of a first sequence is related to a number of first resource elements; where the first sequence is the FD-OCC sequence, and the first resource elements are a plurality of resource elements in frequency domain; or the first sequence is the TD-OCC sequence, and the first resource elements are a plurality of resource elements in time domain.

In a possible implementation, the radio frequency apparatus 152 is further configured to send first information, the first information being used for a terminal to determine the first reference signal. The first information includes at least one of the following: a number of ports of the first reference signal; at least one basic resource set corresponding to the first reference signal; a type of the basic resource set; information of a port multiplexed onto the basic resource set; information of an OCC sequence corresponding to a port of the first reference signal, the OCC sequence including at least one of an FD-OCC sequence and an TD-OCC sequence; and a transmission power of the first reference signal.

In a possible implementation, the at least one basic resource set may include at least two basic resource sets. The at least two basic resource sets correspond to any one of the following: a plurality of repetitions of a basic resource set; a first basic resource set binding, the first basic resource set binding including a plurality of basic resource sets mapped on a plurality of consecutive symbols; and a second basic resource set binding, the second basic resource set binding including a plurality of basic resource sets mapped on a plurality of consecutive PRBs.

In a possible implementation, the number of ports of the first reference signal may be determined based on at least one of the following: a number of ports multiplexed onto the basic resource set; and a number of basic resource sets.

In a possible implementation, a time-frequency resource position corresponding to the first reference signal may be indicated by a bitmap.

In a possible implementation, the bitmap may satisfy at least one of the following: an indication range of the bitmap includes at least one frequency-domain element and at least one time-domain element; each bit in the bitmap corresponds to at least one basic resource set; and a number of first values in the bitmap is the same as the number of ports of the first reference signal.

In a possible implementation, the information of the port multiplexed onto the basic resource set may include at least one of the following: a number of ports multiplexed onto the basic resource set; and an index of the ports multiplexed onto the basic resource set.

In a possible implementation, the information of the OCC sequence corresponding to the port of the first reference signal may include at least one of the following: an OCC sequence corresponding to a port multiplexed onto a basic resource set that corresponds to the first reference signal; an assumed length for demodulating an OCC sequence; and a length of an OCC sequence.

In a possible implementation, the transmission power may be associated with any one of the following: a transmit power of a signal other than the first reference signal; a reference power agreed by default; a reference power configured by the network-side device 1500; a minimum power of a first basic resource set; a maximum power of a first basic resource set; and an average power of a first basic resource set. The first basic resource set is at least one basic resource set within a predetermined range.

In a possible implementation, the transmission power may correspond to one or more of the basic resource sets.

In a possible implementation, the transmission power corresponding to the basic resource set may be determined in any one of the following manners: based on a bitmap; and based on mapping in a specific correspondence order.

In the network-side device provided in the embodiments of this application, the network-side device can send the first reference signal including one or more types of basic resource sets, and the port of the first reference signal is multiplexed onto one or more of the basic resource sets, so that a plurality of reference signals with different numbers of ports can be multiplexed onto the same time-frequency resource, thereby reducing the overall reference signal resource overheads in the network.

It can be understood that for the processes of the implementations mentioned in this embodiment, reference may be made to the relevant descriptions in the foregoing method embodiment of the network-side device, with the same or corresponding technical effects achieved. To avoid repetition, details are not described herein again.

An embodiment of this application further provides a readable storage medium. The readable storage medium stores a program or instructions, and when the program or instructions are executed by a processor, the processes of the foregoing port multiplexing method embodiments are implemented, with the same technical effects achieved. To avoid repetition, details are not described herein again.

The processor is a processor in the terminal in the foregoing embodiments. The readable storage medium includes a computer-readable storage medium, for example, a computer read-only memory ROM, a random access memory RAM, a magnetic disk, or an optical disc. In some examples, the readable storage medium may be a non-transitory readable storage medium.

An embodiment of this application further provides a chip. The chip includes a processor and a communication interface. The communication interface is coupled to the processor. The processor is configured to run a program or instructions to implement the processes of the foregoing port multiplexing method embodiments, with the same technical effects achieved. To avoid repetition, details are not described herein again.

It should be understood that the chip mentioned in the embodiments of this application may also be referred to as a system-level chip, a system chip, a chip system, a system-on-chip, or the like.

An embodiment of this application further provides a computer program/program product, where the computer program/program product is stored in a storage medium, and the computer program/program product is executed by at least one processor to implement the processes of the foregoing port multiplexing method embodiments, with the same technical effects achieved. To avoid repetition, details are not described herein again.

An embodiment of this application further provides a communication system including a terminal and a network-side device. The terminal may be configured to perform the steps of the foregoing method on the terminal side, and the network-side device may be configured to perform the steps of the foregoing method of the network-side device.

It should be noted that in this specification, the terms “include”, “comprise”, or any other variants thereof are intended to cover a non-exclusive inclusion, such that a process, method, article, or apparatus that includes a series of elements includes not only those elements but also other elements that are not expressly listed, or further includes elements inherent to such process, method, article, or apparatus. Without more restrictions, an element preceded by the statement “includes a . . . ” does not preclude the presence of other identical elements in the process, method, article, or apparatus that includes the element. In addition, it should be noted that the scope of the method and apparatus in the embodiments of this application is not limited to functions being performed in the order shown or discussed, but may further include functions being performed at substantially the same time or in a reverse order, depending on the functions involved. For example, the described method may be performed in an order different from the order described, and steps may be added, omitted, or combined. In addition, features described with reference to some examples may be combined in other examples.

Based on the foregoing description of the embodiments, persons skilled in the art can clearly understand that the method in the foregoing embodiments may be implemented through a computer software product on a necessary general hardware platform or certainly through hardware only. The computer software product is stored in a storage medium (for example, a ROM, a RAM, a magnetic disk, or an optical disc), and includes several instructions for instructing a terminal or a network-side device to perform the method described in the embodiments of this application.

The foregoing describes the embodiments of this application with reference to the accompanying drawings. However, this application is not limited to the foregoing specific embodiments. These specific embodiments are merely illustrative rather than restrictive. Inspired by this application, persons of ordinary skill in the art may develop many embodiments in other forms without departing from the essence of this application and the protection scope of the claims, and all such embodiments fall within the protection scope of this application.

What is claimed is:

1. A port multiplexing method, performed by a terminal, comprising:
receiving a first reference signal; wherein
the first reference signal comprises one or more types of basic resource sets, each type of the basic resource sets comprises one or more resource elements, and a port of the first reference signal is multiplexed onto one or more of the basic resource sets.

2. The method according to claim 1, wherein each type of the basic resource sets comprises a plurality of resource elements; wherein
the plurality of resource elements comprise at least one of the following:
a plurality of resource elements that are consecutive or non-consecutive in frequency domain at a same time-domain position;
a plurality of resource elements that are consecutive or non-consecutive in time domain at a same frequency-domain position;
a plurality of resource elements occupying at least one time-domain position; or
a plurality of frequency-domain elements occupying at least one frequency-domain position.

3. The method according to claim 1, wherein the port of the first reference signal is multiplexed in at least one of the following manners:
multiplexing on one of the basic resource sets using a Frequency-Domain Orthogonal Cover Code (FD-OCC) sequence;
multiplexing on one of the basic resource sets using a Time-Domain Orthogonal Cover Code (TD-OCC) sequence;
multiplexing among the basic resource sets using Time Division Multiplexing (TDM); or
multiplexing among the basic resource sets using Frequency Division Multiplexing (FDM).

4. The method according to claim 3, wherein each type of the basic resource sets comprises a plurality of resource elements; and
a length of a first sequence is related to a number of first resource elements; wherein
the first sequence is the FD-OCC sequence, and the first resource elements are a plurality of resource elements in frequency domain; or
the first sequence is the TD-OCC sequence, and the first resource elements are a plurality of resource elements in time domain.

5. The method according to claim 1, wherein the first reference signal is determined by the terminal based on first information sent by a network-side device; wherein
the first information comprises at least one of the following:
a number of ports of the first reference signal;
at least one of the basic resource sets corresponding to the first reference signal;
a type of the basic resource sets;
information of a port multiplexed onto the basic resource sets;
information of an Orthogonal Cover Code (OCC) sequence corresponding to a port of the first reference signal, the OCC sequence comprising at least one of a Frequency-Domain Orthogonal Cover Code (FD-OCC) sequence or a Time-Domain Orthogonal Cover Code (TD-OCC) sequence; or
a transmission power of the first reference signal.

6. The method according to claim 5, wherein the at least one of the basic resource sets comprises at least two basic resource sets; wherein
the at least two basic resource sets correspond to any one of the following:
a plurality of repetitions of one of the basic resource sets;
a first basic resource set binding, wherein the first basic resource set binding comprises a plurality of basic resource sets mapped on a plurality of consecutive symbols; or
a second basic resource set binding, wherein the second basic resource set binding comprises a plurality of basic resource sets mapped on a plurality of consecutive Physical Resource Blocks (PRBs).

7. The method according to claim 5, wherein the number of ports of the first reference signal is determined based on at least one of the following:
a number of ports multiplexed onto the basic resource sets; or
a number of the basic resource sets.

8. The method according to claim 5, wherein a time-frequency resource position corresponding to the first reference signal is indicated by a bitmap; or
wherein the transmission power corresponds to one or more of the basic resource sets.

9. The method according to claim 8, wherein the bitmap satisfies at least one of the following:
an indication range of the bitmap comprises at least one frequency-domain element and at least one time-domain element;
each bit in the bitmap corresponds to at least one of the basic resource sets; or
a number of first values in the bitmap is the same as the number of ports of the first reference signal.

10. The method according to claim 5, wherein the information of the port multiplexed onto the basic resource set comprises at least one of the following:
a number of ports multiplexed onto the basic resource sets; or
an index of the ports multiplexed onto the basic resource sets.

11. The method according to claim 5, wherein the information of the OCC sequence corresponding to the port of the first reference signal comprises at least one of the following:
an OCC sequence corresponding to a port multiplexed onto one of the basic resource sets that corresponds to the first reference signal;
an assumed length for demodulating the OCC sequence; or
a length of the OCC sequence.

12. The method according to claim 5, wherein the transmission power is associated with any one of the following:
a transmit power of a signal other than the first reference signal;
a reference power agreed by default;
a reference power configured by the network-side device;
a minimum power of a first basic resource set;
a maximum power of a first basic resource set; or
an average power of a first basic resource set; wherein
the first basic resource set is at least one basic resource set within a predetermined range.

13. The method according to claim 8, wherein the transmission power corresponding to the basic resource set is determined in any one of the following manners:
based on the bitmap; or
based on mapping in a specific correspondence order.

14. A port multiplexing method, performed by a network-side device, comprising:
sending a first reference signal; wherein
the first reference signal comprises one or more types of basic resource sets, each type of the basic resource sets comprises one or more resource elements, and a port of the first reference signal is multiplexed onto one or more of the basic resource sets.

15. The method according to claim 14, wherein each type of the basic resource sets comprises a plurality of resource elements; wherein
the plurality of resource elements comprise at least one of the following:
a plurality of resource elements that are consecutive or non-consecutive in frequency domain at a same time-domain position;
a plurality of resource elements that are consecutive or non-consecutive in time domain at a same frequency-domain position;
a plurality of resource elements occupying at least one time-domain position; or
a plurality of frequency-domain elements occupying at least one frequency-domain position.

16. The method according to claim 14, wherein the port of the first reference signal is multiplexed in at least one of the following manners:
multiplexing on one of the basic resource sets using a Frequency-Domain Orthogonal Cover Code (FD-OCC) sequence;
multiplexing on one of the basic resource sets using a Time-Domain Orthogonal Cover Code (TD-OCC) sequence;
multiplexing among the basic resource sets using Time Division Multiplexing (TDM); or
multiplexing among the basic resource sets using Frequency Division Multiplexing (FDM).

17. The method according to claim 16, wherein each type of the basic resource sets comprises a plurality of resource elements; and
a length of a first sequence is related to a number of first resource elements; wherein
the first sequence is the FD-OCC sequence, and the first resource elements are a plurality of resource elements in frequency domain; or
the first sequence is the TD-OCC sequence, and the first resource elements are a plurality of resource elements in time domain.

18. The method according to claim 14, further comprising:
sending first information, wherein the first information is used for a terminal to determine the first reference signal; wherein
the first information comprises at least one of the following:
a number of ports of the first reference signal;
at least one of the basic resource sets corresponding to the first reference signal;
a type of the basic resource sets;
information of a port multiplexed onto the basic resource sets;
information of an Orthogonal Cover Code (OCC) sequence corresponding to a port of the first reference signal, the OCC sequence comprising at least one of a Frequency-Domain Orthogonal Cover Code (FD-OCC) sequence or a Time-Domain Orthogonal Cover Code (TD-OCC) sequence; or
a transmission power of the first reference signal.

19. A terminal, comprising:
a memory storing computer-readable instructions; and
a processor coupled to the memory and configured to execute the computer-readable instructions, wherein the computer-readable instructions, when executed by the processor, cause the processor to perform operations comprising:
receiving a first reference signal; wherein
the first reference signal comprises one or more types of basic resource sets, each type of the basic resource sets comprises one or more resource elements, and a port of the first reference signal is multiplexed onto one or more of the basic resource sets.

20. A network-side device, comprising:
a memory storing computer-readable instructions; and
a processor coupled to the memory and configured to execute the computer-readable instructions, wherein the computer-readable instructions, when executed by the processor, cause the processor to perform the port multiplexing method of claim 14.
